(19) United States
(12) Patent Application Publication
(10) Pub. No.: US 2010/0300350 A1
(43) Pub. Date: Dec. 2, 2010

(54) Pressure gauge

(76) Inventor: Wei-Chi Wang, Tainan (TW)

Correspondence Address: COOPER & DUNHAM, LLP, 30 Rockefeller Plaza, 20th Floor, NEW YORK, NY, 10112, US

(21) Appl. No.: 12/455,386

(22) Filed: Jun. 1, 2009

(51) Int. Cl. G01D 13/02

(52) U.S. Cl. 116/284

(57) ABSTRACT

A pressure gauge has a base, a measuring assembly, a dial and a fastener. The base has a chamber and a side opening communicating with the chamber. The measuring assembly is mounted in the chamber and has a tab mount passing through the side opening. The tab mount has a fixing hole. The dial is disposed on the base, covers the measuring assembly and has a tab and a fastening hole. The tab extends through the side opening of the base. The fastening hole is formed through the tab and aligns with the fixing hole of the tab mount. The fastener is mounted through the fixing hole and the fastening hole and thus fixes the dial without being revealed. Therefore aesthetic appearance of the pressure gauge is improved.

### BACKGROUND OF THE INVENTION

1. Field of the Invention

The present invention relates to a pressure gauge, especially to a pressure gauge with internal fasteners for improved aesthetic appearance.

2. Description of the Related Art

A pressure gauge is used to measure pressure of fluids. With reference to FIG. 5, a conventional pressure gauge (70) is applied to an appliance (60) having a fluid, the pressure gauge (70) indicates pressure of the fluid and is mounted on a gauge seat (61) of the appliance (60). The pressure gauge (70) has a base (71), a measuring assembly, a dial (72) and a transparent cover (74). The measuring assembly is mounted in the base (71). The dial (72) is mounted on the base (71) above the measuring assembly with multiple screws (73). The transparent cover (74) is mounted on top of the base (71) to secure the dial (72).

However, heads of the screws (71) are revealed on the dial (72), reduce an aesthetic appearance of the pressure gauge (70) and reduce end value of the pressure gauge (70).

To overcome the shortcomings, the present invention provides a pressure gauge to mitigate or obviate the aforementioned problems.

### SUMMARY OF THE INVENTION

The main objective of the invention is to provide a pressure gauge with improved aesthetic appearance.

The pressure gauge has a base, a measuring assembly, a dial and a fastener. The base has a chamber and a side opening communicating with the chamber. The measuring assembly is mounted in the chamber and has a tab mount passing through the side opening. The tab mount has a fixing hole. The dial is disposed on the base, covers the measuring assembly and has a tab and a fastening hole. The tab extends through the side opening of the base. The fastening hole is formed through the tab and aligns with the fixing hole of the tab mount. The fastener is mounted through the fixing hole and the fastening hole and thus fixes the dial without being revealed. Therefore aesthetic appearance of the pressure gauge is improved.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pressure gauge in accordance with the present invention;

FIG. 2 is an exploded perspective view of the pressure gauge in FIG. 1;

FIG. 3 is a cross sectional side view of the pressure gauge in FIG. 1;

FIG. 4 is a top view of the pressure gauge mounted in an appliance; and

FIG. 5 is a top view of a conventional pressure gauge mounted in an appliance.

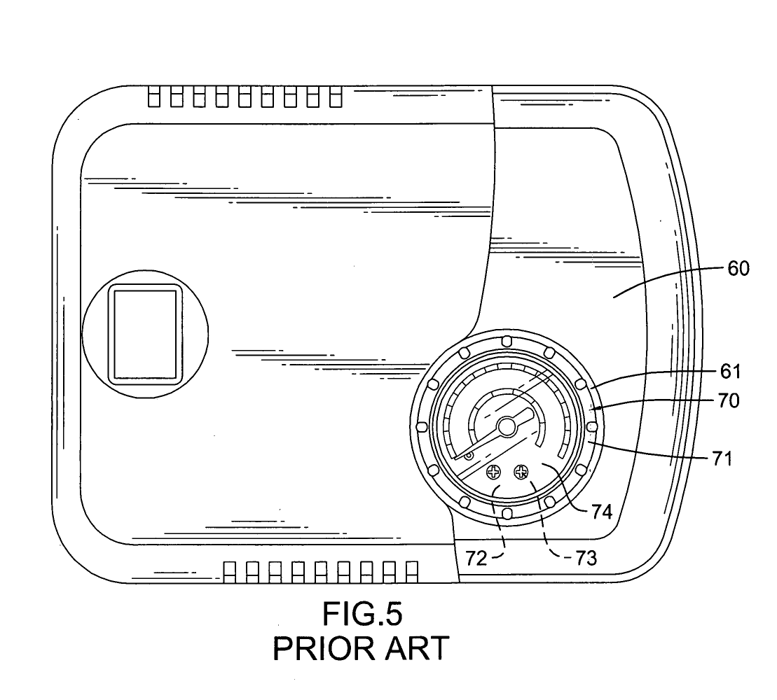

### DETAILED DESCRIPTION OF THE PREFERRED EMBODIMENTS

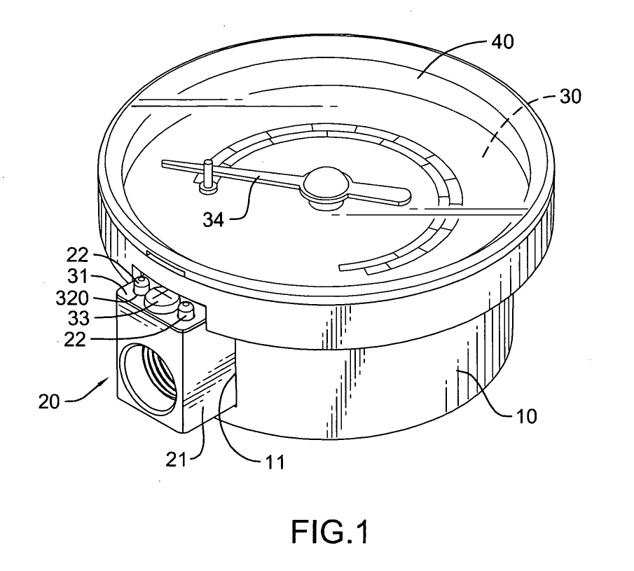

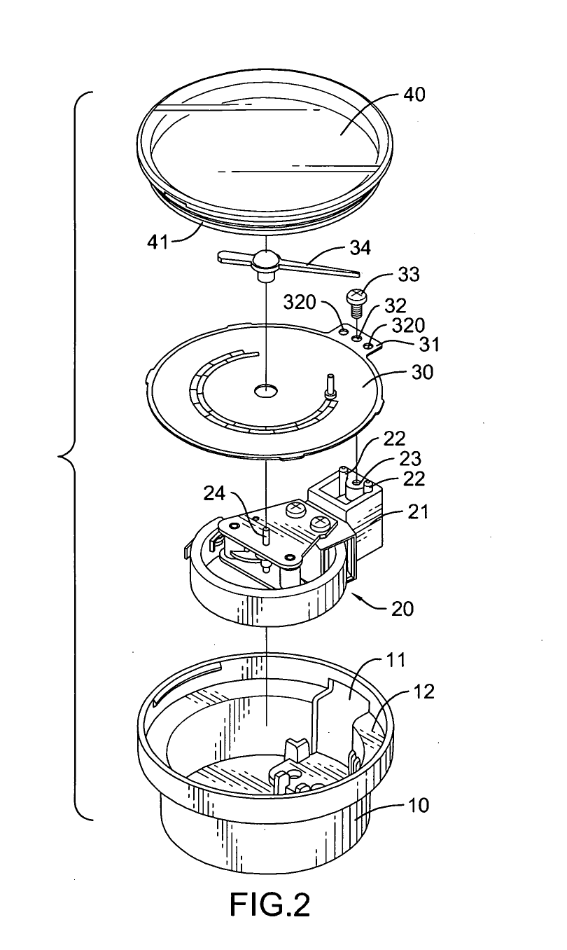

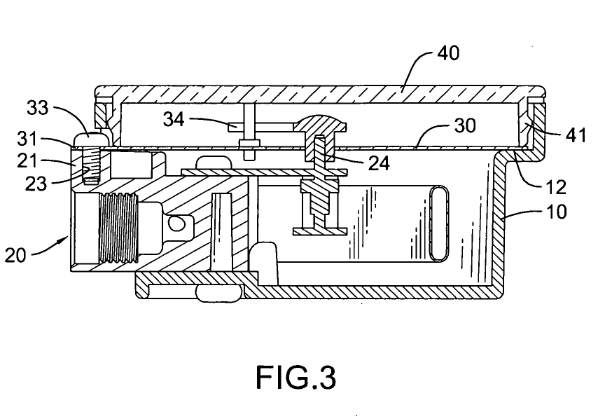

With reference to FIGS. 1, 2 and 3, a pressure gauge in accordance with the present invention comprises a base (10), a measuring assembly (20), a dial (30), at least one fastener (33) and may have a pointer (34) and a transparent cover (40).

The base (10) has a top opening, a chamber, a sidewall and a side opening (11) and may have a shoulder (12). The chamber is formed in the base and communicates with the top opening. The side opening (11) is formed through the sidewall and communicates with the chamber. The shoulder (12) is formed around the top opening of the base (10) and may be threaded, have an annulus or the like.

The measuring assembly (20) is mounted in the chamber of the base (10) and has a body and a tab mount (21). The body is disposed in the chamber and has a side and may have a spindle (24). The tab mount (21) is attached to the side of the body and passes through the side opening (11) of the base (10) and has a top, at least one fixing hole (23) and may have at least one positioning protrusion (22). The at least one fixing hole (23) is formed in the top of the tab mount (21). The at least one positioning protrusion (22) is formed on the top of the tab mount (21). Preferably one fixing hole (23) and two positioning protrusions (22) are implemented and the fixing hole (23) is disposed between the positioning protrusions (22).

The dial (30) is disposed on the top opening of the base (10), covers the measuring assembly (20) and has a rim, a tab (31) and at least one fastening hole (32) and may have at least one positioning hole (320) and may be mounted around the spindle (24). The tab (31) is formed on and extends from the rim through the side opening (11) of the base (10). The at least one fastening hole (32) is formed through the tab (31) and aligns with the at least one fixing hole (23) of the tab mount (21). The at least one positioning hole (320) is formed through the tab (31) and correspondingly mounted around the at least one positioning protrusion (22) of the tab mount (21). Preferably one fastening hole (32) and two positioning holes (320) are implemented, wherein the fastening hole (32) is disposed between the positioning holes (320).

The at least one fastener (33) is correspondingly mounted in the at least one fixing hole (23) through the at least one fastening hole (32). Therefore the dial (30) is securely fixed on the body of the measuring assembly (20).

The pointer (34) is attached to the spindle (24) of the measuring assembly (20). The pointer (34) rotates with the spindle (24) and points to a scale on the dial (30) to indicate a corresponding pressure value.

The transparent cover (40) is mounted on top opening of the base (10) to secure the pointer (34) and the dial (30) and has an engaging ring (41). The engaging ring (41) is formed on and protrudes from a bottom of the transparent cover (40), engages the shoulder (12) of the base (10) wherein the shoulder (12) may be threaded, have an annulus or the like.

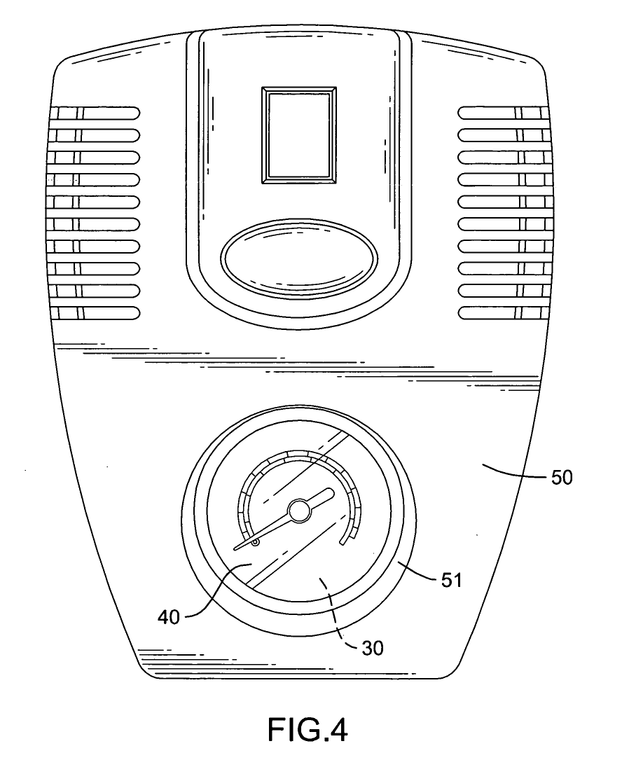

With further reference to FIG. 4, the fastener (33) fixes the dial (30), but is not revealed through the transparent cover (40) when the pressure gauge is mounted in a seat (51) of a casing of an appliance (50). Hence aesthetic appearance of the pressure gauge is improved.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pressure gauge comprising:
a base having
a top opening;
a chamber formed in the base and communicating with the top opening;
a sidewall; and
a side opening formed through the sidewall and communicating with the chamber;
a measuring assembly mounted in the chamber of the base and having
a body disposed in the chamber and having a side; and
a tab mount attached to the side of the body and passing through the side opening of the base and having
a top; and
at least one fixing hole formed in the top;
a dial disposed on the top opening of the base, covering the measuring assembly and having
a rim;
a tab formed on and extending from the rim through the side opening of the base; and
at least one fastening hole formed through the tab and aligns with the at least one fixing hole of the tab mount; and
at least one fastener correspondingly mounted in the at least one fixing hole and through the at least one fastening hole.

2. The pressure gauge as claimed in claim 1, wherein
the tab mount further has at least one positioning protrusion formed on the top of the tab mount; and
the dial further has at least one positioning hole formed through the tab of the dial and correspondingly mounted around the at least one positioning protrusion of the tab mount.

3. The pressure gauge as claimed in claim 1, wherein
the tab mount of the measuring assembly has one fixing hole and two positioning protrusions, wherein the fixing hole is disposed between the positioning protrusions; and
the tab of the dial has one fastening hole and two positioning holes.

4. The pressure gauge as claimed in claim 1, wherein further comprises
a transparent cover mounted on top opening of the base, the transparent cover having an engaging ring formed on and protruding from a bottom of the transparent cover; and
the base further has a shoulder formed around the top opening of the base and engaging the engaging ring of the transparent cover.

5. The pressure gauge as claimed in claim 1, wherein
the body of the measuring assembly further has a spindle;
the dial is mounted around the spindle; and
the pressure gauge further comprises a pointer attached to the spindle of the measuring assembly.

6. The pressure gauge as claimed in claim 2, wherein further comprises
a transparent cover mounted on top opening of the base, the transparent cover having an engaging ring formed on and protruding from a bottom of the transparent cover; and
the base further has a shoulder formed around the top opening of the base and engaging the engaging ring of the transparent cover.

7. The pressure gauge as claimed in claim 2, wherein
the body of the measuring assembly further has a spindle;
the dial is mounted around the spindle; and
the pressure gauge further comprises a pointer attached to the spindle of the measuring assembly.

8. The pressure gauge as claimed in claim 3, wherein further comprises
a transparent cover mounted on top opening of the base, the transparent cover having an engaging ring formed on and protruding from a bottom of the transparent cover; and
the base further has a shoulder formed around the top opening of the base and engaging the engaging ring of the transparent cover.

9. The pressure gauge as claimed in claim 3, wherein
the body of the measuring assembly further has a spindle;
the dial is mounted around the spindle; and
the pressure gauge further comprises a pointer attached to the spindle of the measuring assembly.

10. The pressure gauge as claimed in claim 4, wherein
the body of the measuring assembly further has a spindle;
the dial is mounted around the spindle; and
the pressure gauge further comprises a pointer attached to the spindle of the measuring assembly.

11. The pressure gauge as claimed in claim 6, wherein
the body of the measuring assembly further has a spindle;
the dial is mounted around the spindle; and
the pressure gauge further comprises a pointer attached to the spindle of the measuring assembly.

12. The pressure gauge as claimed in claim 8, wherein
the body of the measuring assembly further has a spindle;
the dial is mounted around the spindle; and
the pressure gauge further comprises a pointer attached to the spindle of the measuring assembly.
